(19) United States
(12) Patent Application Publication
(10) Pub. No.: US 2025/0214355 A1
(43) Pub. Date: Jul. 3, 2025

(54) PRINTING APPARATUS

(71) Applicant: SEIKO EPSON CORPORATION, Tokyo (JP)

(72) Inventors: Masashi OGAWA, SHIOJIRI-SHI (JP); Nobuyuki NISHI, HARA-MURA (JP)

(21) Appl. No.: 19/001,781

(22) Filed: Dec. 26, 2024

(30) Foreign Application Priority Data
Dec. 27, 2023 (JP) 2023-220614

(51) Int. Cl. B41J 13/03; B41J 11/00; B41J 13/076

(52) U.S. Cl. CPC B41J 13/03; B41J 11/0095; B41J 13/076

(57) ABSTRACT

A printing apparatus includes: a feeding roller configured to transport a medium from an accommodation unit to a feeding path; an intermediate roller provided downstream of the feeding roller; a first motor; and a power transmitting unit configured to transmit power from the first motor to the feeding roller and the intermediate roller, in which the power transmitting unit includes a connecting portion in a transmission path configured to transmit power of the first motor to the intermediate roller, and when external force acts, the connecting portion allows the intermediate roller to rotate in accordance with the external force, the external force causing the intermediate roller to rotate in a direction in which the medium is transported downstream.

The present application is based on, and claims priority from JP Application Serial Number 2023-220614, filed on Dec. 27, 2023, the disclosure of which is hereby incorporated by reference herein in its entirety.

### BACKGROUND

### 1. Technical Field

The present disclosure relates to a printing apparatus.

### 2. Related Art

JP-A-2015-513 discloses a printing apparatus including a supplying roller, an intermediate roller, a printing roller, a first motor, a second motor, a switch gear mechanism, and a control unit. The supplying roller supplies a printing medium to a transport path from an accommodation unit configured to accommodate the printing medium. The intermediate roller is disposed in the transport path to transport the printing medium. The printing roller is disposed in a printing path to transport the printing medium. The printing path is disposed downstream of the transport path and is configured to perform a printing process to the printing medium. The first motor rotates the supplying roller and the intermediate roller. The second motor rotates the printing roller. The switch gear mechanism switches between rotation of the intermediate roller and rotation of the supplying roller and the intermediate roller in accordance with the rotational direction of the first motor. The control unit performs a first transport mode and a second transport mode. In the first transport mode, the printing medium is supplied and transported with rotation of the first motor in a predetermined direction. In the second transport mode, the printing medium is transported with rotation of the first motor in an opposite direction to the predetermined direction.

For example, in the printing apparatus in JP-A-2015-513, during the printing process performed to a printing medium transported in the second transport mode, the control unit switches the transport mode from the second transport mode to the first transport mode in order to feed the next printing medium. At the time of switching the transport mode from the second transport mode to the first transport mode, there occurs a moment at which rotation of the intermediate roller stops. In this case, at a moment at which rotation of the intermediate roller stops, transportation of the printing medium is blocked during the printing process, which more likely causes a deterioration in printing quality or malfunction of transportation. Thus, when the next printing medium is fed during the printing process, the transport mode needs to be switched from the second transport mode to the first transport mode after the end of transportation of a printing medium by the intermediate roller during the printing process. This leads to a delay in the timing of starting to feed the next printing medium, which leads to a possibility that the throughput deteriorates at the time of consecutively performing printing on a plurality of printing media.

### SUMMARY

A printing apparatus includes a feeding roller configured to transport a medium from an accommodation unit configured to accommodate the medium, the feeding roller being provided in a transport path disposed downstream of the accommodation unit in a transport direction in which the medium is transported, an intermediate roller provided in the transport path and at a position downstream of the feeding roller and configured to transport the medium, a printing roller provided at a position downstream of the intermediate roller and configured to transport the medium toward a medium support portion at which printing is performed on the medium, a first motor configured to rotate the feeding roller and the intermediate roller through a power transmitting unit, the power transmitting unit configured to transmit power of the first motor to the feeding roller and the intermediate roller, and a second motor configured to rotate the printing roller, in which the power transmitting unit includes a connecting portion in a transmission path configured to transmit power of the first motor to the intermediate roller, and when external force acts, the connecting portion allows the intermediate roller to rotate in accordance with the external force, the external force causing the intermediate roller to rotate in a direction in which the medium is transported downstream.

### BRIEF DESCRIPTION OF THE DRAWINGS

FIG. 1 is a side diagram schematically illustrating one embodiment of a printing apparatus.

FIG. 2 is a perspective view illustrating a power transmitting unit that transmits power of a first motor.

FIG. 3 is a flowchart showing processes performed by a control unit when a feeding process is performed.

FIG. 4 is a side diagram schematically illustrating a medium transported along the transport path.

FIG. 5 is a side diagram schematically illustrating a medium transported along the transport path.

FIG. 6 is a side diagram schematically illustrating a medium transported along the transport path.

FIG. 7 is a side diagram schematically illustrating a medium transported along the transport path.

### DESCRIPTION OF EMBODIMENTS

Below, the present disclosure will be described on the basis of embodiment. In each of the drawings, the same reference characters are attached to the same members, and explanation thereof will not be repeated. Note that, in the present specification, terms “same”, “identical”, and “simultaneously” do not only mean being completely the same. For example, in the present specification, the terms “same”, “identical”, and “simultaneously” include being the same with measurement errors being considered. Furthermore, for example, in the present specification, the terms “same”, “identical”, and “simultaneously” include being the same with manufacturing variations of members being considered.

For example, in the present specification, the terms “same”, “identical”, and “simultaneously” include being the same as long as functions are not impaired. Thus, for example, “both dimensions are the same” means that a dimensional difference between both the dimensions falls within ±5% of either of the dimensions, and particularly preferably falls within ±3% in consideration of measurement errors and manufacturing variations of members.

### 1. First Embodiment

For example, a printing apparatus 1 is an ink-jet type printer configured to be able to perform printing on a sheet-fed printing sheet or the like serving as one example of a medium P.

Note that, X, Y, and Z in each of the drawings indicate three spatial axes orthogonal to each other. In the present description, directions along these axes are an X-axis direction, a Y-axis direction, and a Z-axis direction. When a direction needs to be specified, positive and negative signs are used to indicate the direction by attaching a sign “+” for a positive direction and a sign “−” for a negative direction, and the + direction indicates a direction toward which an arrow in each drawing is directed whereas the − direction indicates a direction opposite to the arrowed direction.

In addition, the Z-axis direction indicates a direction of gravity. The +Z direction indicates a vertically upward direction, and the −Z direction indicates a vertical downward direction. Furthermore, a plane including the X-axis and the Y-axis is described as an X-Y plane. A plane including the X-axis and the Z-axis is described as an X-Z plane. A plane including the Y-axis and the Z-axis is described as a Y-Z plane. In addition, the X-Y plane is a horizontal plane. Furthermore, the three spatial axes of X, Y, and Z for which no limitation is applied in terms of positive and negative directions are described as the X-axis, Y-axis, and Z-axis.

The X-axis direction is a width direction of the printing apparatus 1, and is also a width direction of the medium P on which printing is performed. When viewed from an operator positioned at the front face side of the printing apparatus 1, the +X direction is the right side, and the −X direction is the left side.

The Y-axis direction is a depth direction of the printing apparatus 1, and is also a direction along a transport direction of the medium P at the time of printing. The +Y direction is a direction from the front face of the printing apparatus 1 toward the back surface, and −Y direction is a direction from the back surface of the printing apparatus 1 toward the front face. In the present embodiment, of side surfaces that constitute the periphery of the printing apparatus 1, a side surface at the −Y direction constitutes the front face of the printing apparatus 1, and a side surface at the +Y direction constitutes the back surface of the printing apparatus 1.

Hereinafter, a direction in which the medium P is sent is referred to as “downstream”, and a direction opposite thereto is referred to as “upstream”.

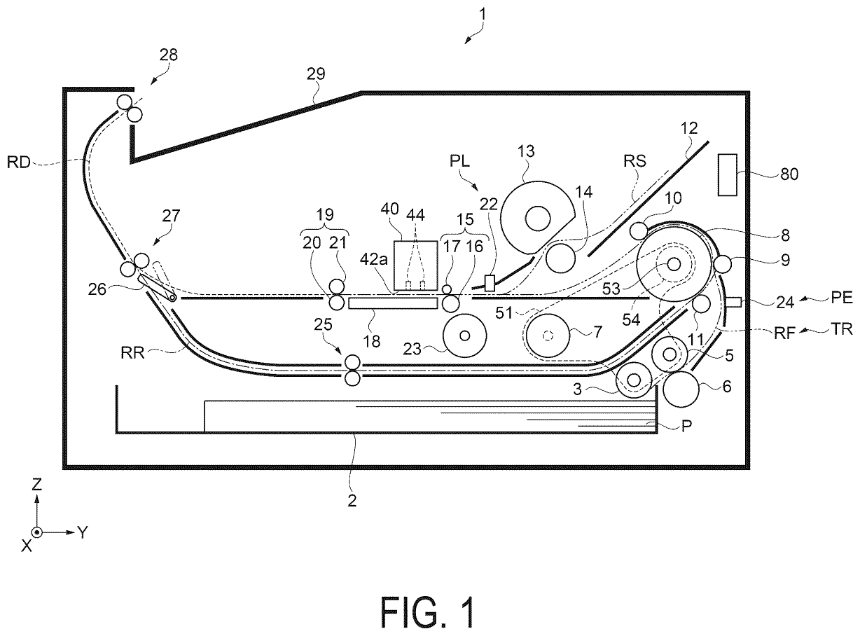

Below, with reference to FIG. 1, component members that the printing apparatus 1 includes will be described along a transport path TR provided in the printing apparatus 1. The transport path TR includes a feeding path RF, a supplying path RS, a discharging path RD, and a returning path RR. The feeding path RF, the supplying path RS, the discharging path RD, and the returning path RR serve as one example of the transport path TR.

As illustrated in FIG. 1, the printing apparatus 1 includes a cassette-type accommodation unit 2 at a bottom of the apparatus. A medium P is accommodated in the accommodation unit 2. The accommodation unit 2 is provided so as to be able to be attached to and detached from the front face side of the apparatus.

The printing apparatus 1 includes a pick roller 3 provided above the accommodation unit 2 and driven by a first motor 7 through a power transmitting unit 51. The power transmitting unit 51 will be described later. The pick roller 3 is able to advance to or retreat from the medium P accommodated in the accommodation unit 2. The pick roller 3 rotates while coming into contact with the medium P accommodated in the accommodation unit 2, thereby sending the medium P from the accommodation unit 2 to the +Y direction.

In the feeding path RF disposed downstream of the accommodation unit 2, the printing apparatus 1 includes a feeding roller 5 and a separation roller 6 to which rotational torque is applied by a torque limiter that is not illustrated in the drawing. The feeding roller 5 is driven by the first motor 7 through the power transmitting unit 51. The medium P sent from the accommodation unit 2 is nipped by the feeding roller 5 and the separation roller 6 to be separated, and is transported downstream of the feeding roller 5 and the separation roller 6 in the feeding path RF.

The printing apparatus 1 includes a medium detector 24 disposed at a position downstream of the feeding roller 5 and the separation roller 6 in the feeding path RF. The medium detector 24 is provided at a position PE downstream of the feeding roller 5 and the separation roller 6 in the feeding path RF. The medium detector 24 is able to detect whether or not the medium P passes through the position PE. The position PE serves as one example of a predetermined position.

For the medium detector 24, it is possible to use a reflection-type photosensor, a transmissive-type photosensor, or the like disposed so as to be able to output light toward the position PE. For example, a control unit 80 that will be described later is able to determine the timing of transporting the medium P to the feeding path RF on the basis of detection information from the medium detector 24.

In the feeding path RF, the printing apparatus 1 includes an intermediate roller 8 at a position downstream of the feeding roller 5, the separation roller 6, and the medium detector 24. The intermediate roller 8 is driven by the first motor 7 through the power transmitting unit 51. Nip rollers 9, 10, and 11 are provided around the intermediate roller 8. The nip rollers 9 and 10 together with the intermediate roller 8 constitute a portion of the feeding path RF. The nip roller 11 together with the intermediate roller 8 constitutes a portion of the returning path RR.

The nip roller 10 is disposed downstream of the nip roller 9 in the feeding path RF. The medium P is nipped by the intermediate roller 8 and the nip roller 9 and is further nipped by the intermediate roller 8 and the nip roller 10 to be transported downstream. The transport direction of the medium P is inverted by the intermediate roller 8 from the +Y direction to the −Y direction, and is transported downstream.

The printing apparatus 1 includes a medium detector 22 disposed at a position downstream of the intermediate roller 8 in the feeding path RF. The medium detector 22 is provided at a position PL downstream of the intermediate roller 8 in the feeding path RF. The medium detector 22 is provided so as to be able to detect whether or not the leading end of the medium P reaches the position PL.

For the medium detector 22, it is possible to use a reflection-type photosensor, a transmissive-type photosensor, or the like disposed so as to be able to output light toward the position PL. For example, the control unit 80 is able to determine the position of the leading end of the medium P with respect to a printing head 40 on the basis of detection information from the medium detector 22. In addition, the control unit 80 is able to position the medium P at the printing start position.

The printing apparatus 1 includes a supplying path RS from a supply tray 12, in addition to the feeding path RF from the accommodation unit 2. The supply tray 12 that constitutes the supplying path RS is configured to support the medium P in a sloped posture. The printing apparatus 1 includes a supplying roller 13 and a separation roller 14 in the supplying path RS. The supplying roller 13 is driven by the first motor 7 through the power transmitting unit 51. The supplying roller 13 may be driven by a supply motor that is not illustrated in the drawing.

Rotational torque is applied to the separation roller 14 by a torque limiter that is not illustrated in the drawing. The medium P supported by the supply tray 12 is transported by the supplying roller 13 and the separation roller 14 toward the feeding path RF disposed downstream. The supplying path RS merges with the feeding path RF at a position of the feeding path RF between the medium detector 22 and a nip portion comprised of the intermediate roller 8 and the nip roller 10.

The printing apparatus 1 includes a printing roller pair 15. The printing roller pair 15 is provided downstream of the intermediate roller 8 and the medium detector 22. The printing roller pair 15 includes a printing roller 16 and a driven roller 17 configured so as to be able to rotate in a following manner. The printing roller 16 is driven by the second motor 23.

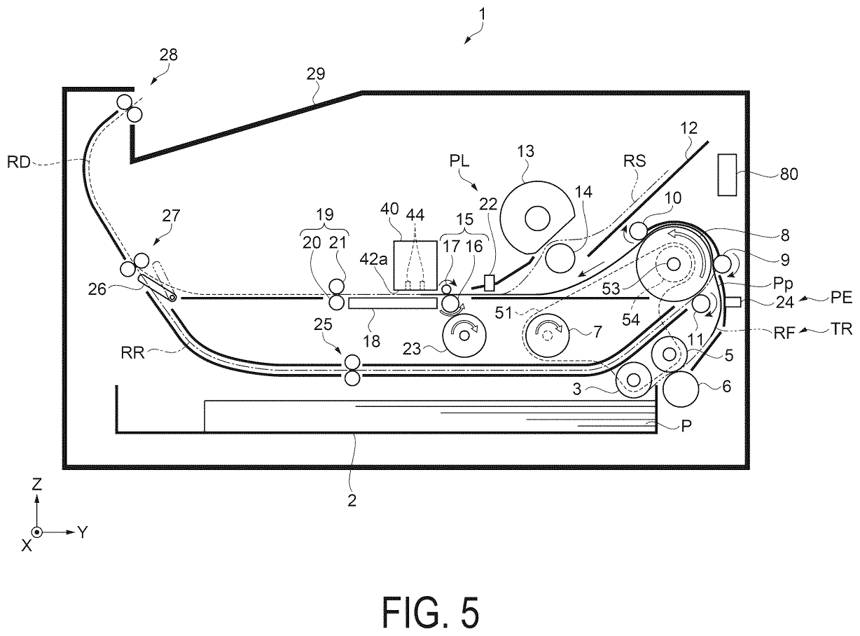

For example, it is assumed that printing is performed on the medium P. At this time, the second motor 23 is driven to rotate in a direction in which the output shaft of the second motor 23 rotates clockwise when the second motor 23 is viewed from the +X direction side, as illustrated in FIG. 5. Thus, as the printing roller 16 rotates counterclockwise when the printing roller 16 is viewed from the +X direction side, the medium P is transported toward a medium support portion 18 downstream of the printing roller pair 15.

The printing apparatus 1 includes the medium support portion 18 at a position downstream of the printing roller pair 15. The medium support portion 18 is configured to support the medium P transported by the printing roller pair 15. By supporting the medium P, the medium support portion 18 defines a gap between the medium P and an ejection surface 42a of a printing head 40 that will be described later. Hereinafter, the gap between the medium P and the ejection surface 42a may be also referred to as a printing gap. Printing on the medium P by the printing head 40 that will be described later is performed at the medium support portion 18.

The printing apparatus 1 includes the printing head 40 disposed at the +Z direction side of the medium support portion 18. The printing head 40 includes the ejection surface 42a. The ejection surface 42a is opposed to a surface of the medium support portion 18 that supports the medium P. A plurality of nozzles 44 are formed in the ejection surface 42a. The printing head 40 ejects ink from the plurality of nozzles 44 to the medium P supported by the medium support portion 18, to perform printing. The ink serves as one example of a liquid.

The printing head 40 is a so-called line head in which the plurality of nozzles 44 are arrayed so as to cover the entire area of the medium width direction along the X-axis direction. The printing head 40 is elongated in the medium width direction, and is configured as a liquid ejecting head configured to be able to perform printing over the entire width area of the medium without involving movement in the medium width direction.

The ejection surface 42a is opposed to the medium P supported by the medium support portion 18. The ejection surface 42a can be called a liquid ejection surface or a nozzle surface. The printing apparatus 1 includes a liquid accommodation unit that is not illustrated in the drawing. The ink to be ejected from the printing head 40 is supplied to the printing head 40 from the liquid accommodation unit through a supply tube that is not illustrated in the drawing.

The printing head 40 is provided so as to be able to move in a direction in which it advances toward or retreats from the medium support portion 18 using a gap adjusting mechanism (not illustrated), that is, in a direction in which the printing gap is adjusted. In the present embodiment, the direction in which the printing gap is adjusted is a direction along the Z-axis direction.

The printing apparatus 1 includes a rearward feeding roller pair 19. The rearward feeding roller pair 19 is provided at a position downstream of the medium support portion 18. The rearward feeding roller pair 19 includes a rearward feeding roller 20 driven by a rearward feeding motor (not illustrated), and a driven roller 21 configured to be able to rotate in a following manner. With the rearward feeding roller 20 being driven, the medium P on which printing is performed is transported toward the discharging path RD downstream of the rearward feeding roller pair 19. The rearward feeding roller 20 may be driven by the second motor 23 through a transmission mechanism (not illustrated).

The printing apparatus 1 includes a switching flap 26 in the discharging path RD. The switching flap 26 is provided in the discharging path RD so as to be able to move to a discharging position illustrated by the solid line in FIG. 1 and a returning position illustrated by the long dashed double-short dashed line, with an actuator (not illustrated) being driven.

The discharging position is a position at which the medium P is transported to the discharging path RD downstream with the rearward feeding roller 20 being driven to rotate. The returning position is a position at which the medium P transported to the discharging path RD is transported toward the returning path RR. As for an actuator used to move the switching flap 26 into the discharging position and the returning position, it is possible to use an electromagnetic solenoid or the like, for example.

The printing apparatus 1 includes a conveying roller pair 27. The conveying roller pair 27 is provided at a position downstream of the switching flap 26 in the discharging path RD. The printing apparatus 1 includes a discharging roller pair 28. The discharging roller pair 28 is provided at a position downstream of the conveying roller pair 27 in the discharging path RD. The conveying roller pair 27 and the discharging roller pair 28 are driven by a discharging motor that is not illustrated in the drawing. The conveying roller pair 27 and the discharging roller pair 28 are able to rotate in one way when the medium P is transported in a discharging direction and in the other way when the medium P is transported in a returning direction.

When the conveying roller pair 27 and the discharging roller pair 28 rotate in the one way, the medium P existing in the discharging path RD is transported in the discharging direction toward a discharging tray 29 provided downstream in the discharging path RD. The medium P on which printing has been performed and which is transported in the discharging direction is discharged to the discharging tray 29 by the discharging roller pair 28 in a state where the most recently printed surface is set as the lower surface that is a surface at the −Z direction.

When the conveying roller pair 27 and the discharging roller pair 28 rotate in the other way, the medium P existing in the discharging path RD is transported in the returning direction toward the returning path RR.

The returning path RR is a path through which the medium P is transported at the time of performing both-side printing in which printing is performed on both surfaces of the medium P. The returning path RR links the conveying roller pair 27 and a nip portion comprised of the intermediate roller 8 and the nip roller 9 to each other.

The printing apparatus 1 includes a returning roller pair 25 in the returning path RR. For example, when both-side printing is performed on the medium P, the returning roller pair 25 is driven by a returning motor that is not illustrated in the drawing. The returning roller pair 25 transports the medium P transported from the discharging path RD to the returning path RR, toward a nip portion constituting the returning path RR and comprised of the nip roller 11 and the intermediate roller 8.

At this time, the medium P is transported by the returning roller pair 25 in a state where the printed surface on which printing is previously performed is set as the upper surface that is a surface at the +Z direction side. In the returning path RR, the medium P transported by the returning roller pair 25 is nipped by the rotating intermediate roller 8 and the nip roller 11. The medium P nipped by the intermediate roller 8 and the nip roller 11 is transported toward a nip portion comprised of the intermediate roller 8 and the nip roller 9 that is at the downstream.

The medium P nipped by the rotating intermediate roller 8 and the nip roller 9 is transported downstream of the nip portion comprised of the intermediate roller 8 and the nip roller 9. The medium P that is transported to the feeding path RF again is transported toward the medium support portion 18 by the intermediate roller 8, the nip roller 10, and the printing roller pair 15. At this time, the medium P is transported toward the medium support portion 18 in a state where the printed surface on which printing is previously performed is set as the lower surface that is a surface at the −Z direction side.

Printing is perform by the printing head 40 on the medium P transported by the medium support portion 18 in a state where the printed surface on which printing has already been performed is set as the lower surface. Thus, both-side printing is performed on the medium P. The medium P on which both-side printing has been performed passes through the rearward feeding roller pair 19 and the switching flap 26 disposed at the discharging position, and is transported to the discharging path RD.

The medium P transported to the discharging path RD is transported by the conveying roller pair 27 in the discharging direction toward the discharging roller pair 28. The medium P on which both-side printing has been performed is discharged by the discharging roller pair 28 to the discharging tray 29 in a state where the most recently printed surface is set as the lower surface that is a surface at the −Z direction.

The printing apparatus 1 includes the power transmitting unit 51. The power transmitting unit 51 is configured to transmit the power of the first motor 7 to the intermediate roller 8, the feeding roller 5, and the pick roller 3. The power transmitting unit 51 is provided so as to be able to switch the destination of transmission of the power of the first motor 7 in accordance with the rotational direction of the output shaft of the first motor 7. In the present embodiment, the power transmitting unit 51 also transmits the power of the first motor 7 to the supplying roller 13.

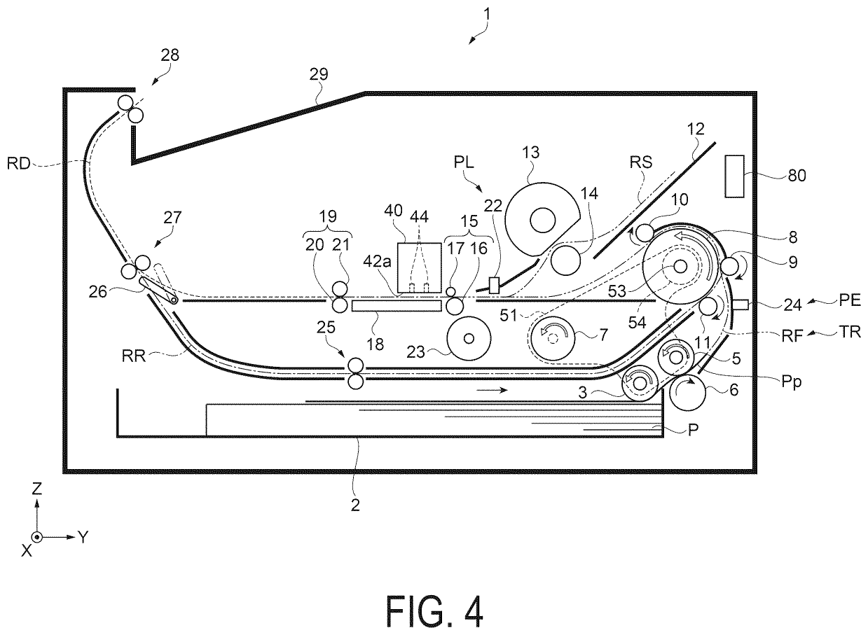

A “transport mode” represents transportation of the medium P by the first motor 7 and the power transmitting unit 51 when the output shaft of the first motor 7 rotates clockwise when the first motor 7 is viewed from the +X direction side as illustrated in FIG. 5. A “feeding mode” represents transportation of the medium P by the first motor 7 and the power transmitting unit 51 when the output shaft of the first motor 7 rotates counterclockwise when the first motor 7 is viewed from the +X direction side as illustrated in FIG. 4.

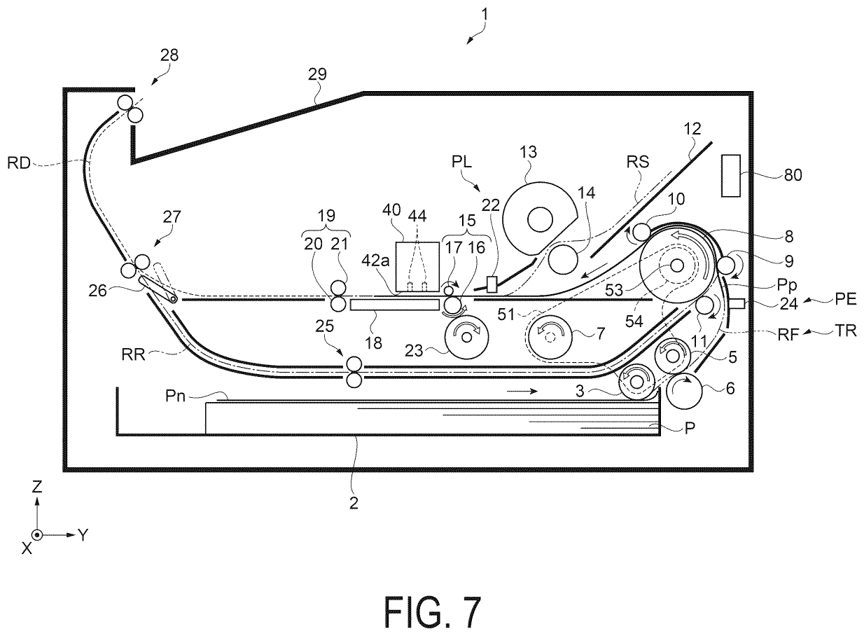

Note that, in FIGS. 4 to 7, of the medium P, a preceding medium Pp represents a medium P that is being transported. In FIG. 7, of the medium P, a next medium Pn represents a medium P transported subsequent to the preceding medium Pp. In FIGS. 4 to 7, when the rotational direction of each of the rollers is indicated by the black marking arrow, it is indicated that the roller is passively rotated in association with the external force or the like that acts thereon.

Hereinafter, clockwise rotation of the output shaft of the first motor 7 is expressed as “first motor 7 rotates clockwise”. Counterclockwise rotation of the output shaft of the first motor 7 is expressed as “first motor 7 rotates counterclockwise”. As for the rotational direction of the output shaft of the first motor 7, “clockwise” serves as one example of one direction, and “counterclockwise” serves as one example of the other direction.

In the transport mode in which the first motor 7 rotates clockwise as illustrated in FIG. 5, the power transmitting unit 51 transmits the power of the first motor 7 to the intermediate roller 8. In this mode, as the intermediate roller 8 and the nip rollers 9 and 10 rotate in the direction of the arrow, the medium P existing in the feeding path RF is transported downstream that is the direction of the arrow.

In the feeding mode in which the first motor 7 rotates counterclockwise as illustrated in FIG. 4, the power transmitting unit 51 transmits the power of the first motor 7 to the intermediate roller 8, the feeding roller 5, and the pick roller 3. In this mode, as the pick roller 3, the feeding roller 5, and the separation roller 6 rotate in the direction of the arrow, the medium P is transported from the accommodation unit 2 toward the downstream that is the direction of the arrow.

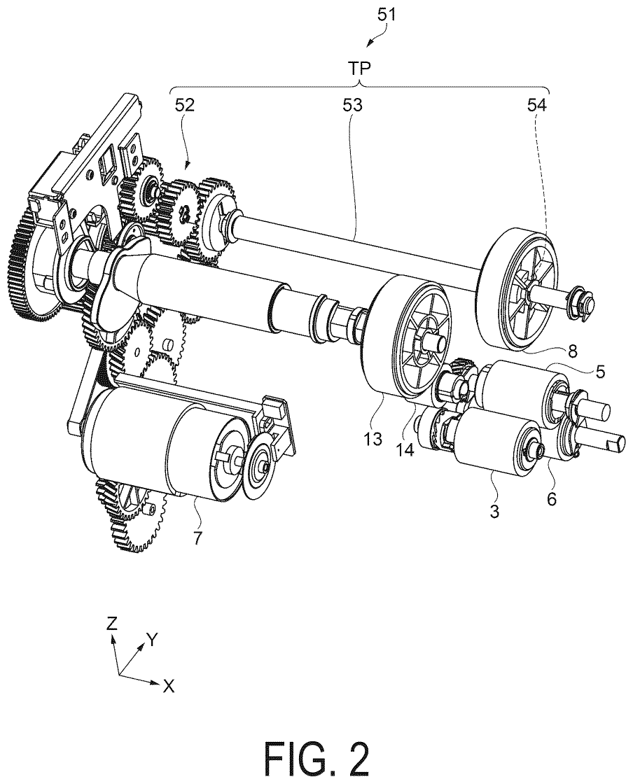

As illustrated in FIG. 2, the power transmitting unit 51 includes a transmission path TP in which the power of the first motor 7 is transmitted to the intermediate roller 8. The transmission path TP includes a toothed-gear train 52 including a plurality of toothed gears, a drive shaft 53, a one-way clutch 54, and the like.

The drive shaft 53 is provided rotatably around the shaft center along the X-axis. The intermediate roller 8 is provided at an end of the +X direction side of the drive shaft 53. As the power of the first motor 7 is transmitted from the toothed-gear train 52, the drive shaft 53 and the intermediate roller 8 rotate around the shaft center.

In the transmission path TP, the one-way clutch 54 may be provided at the toothed-gear train 52, for example. However, the one-way clutch 54 in the present embodiment is provided between the intermediate roller 8 and the drive shaft 53.

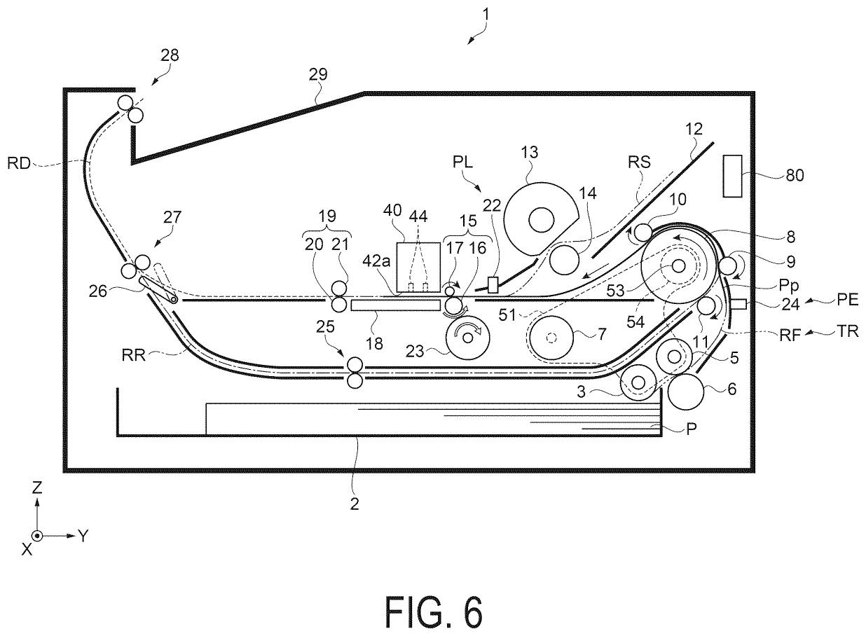

When external force acts such that the intermediate roller 8 rotates in a direction (see FIG. 6) in which the medium P is transport downstream, the one-way clutch 54 allows the intermediate roller 8 to rotate in accordance with the external force. At this time, with the drive shaft 53 being the rotary shaft, the intermediate roller 8 rotates with respect to the drive shaft 53 in accordance with the external force. The one-way clutch 54 serves as one example of a connecting portion that the power transmitting unit 51 includes in the transmission path TP.

The one-way clutch 54 in the present embodiment is provided between the drive shaft 53 and the intermediate roller 8 having an outer diameter larger than the toothed gear that constitutes the toothed-gear train 52. This configuration makes it easy to dispose the one-way clutch 54 at the inside of the intermediate roller 8 that is disposed between the intermediate roller 8 and the drive shaft 53. Thus, as the power transmitting unit 51 includes the one-way clutch 54 in the transmission path TP, it is possible to easily suppress an increase in the size of the printing apparatus 1.

For the one-way clutch 54 in the present embodiment, it is possible to employ a roller-type one-way clutch having a tubular outer shape (see FIG. 1), for example. In this case, the one-way clutch 54 is configured to include an outer ring and an inner ring that form a tubular shape, and also include a plurality of rollers and springs that are provided between the inner ring and a cam surface formed at the inner surface of the outer ring. The intermediate roller 8 is attached to the drive shaft 53 such that the outer ring of the one-way clutch 54 is fixed at the center of the intermediate roller 8, and the inner ring is fixed to the drive shaft 53.

The one-way clutch 54 may be of a planetary-gear type including planetary gear, in place of the rollers and springs of the roller type. In this case, teeth configured to make the drive shaft 53 function as a sun gear may be provided on the peripheral surface of the drive shaft 53 to which the one-way clutch 54 is attached.

As illustrated in FIG. 1, the printing apparatus 1 includes the control unit 80. The control unit 80 controls the whole of the printing apparatus 1. The control unit 80 may include a processor that executes various types of processes in accordance with a program, a dedicated hardware circuit such as an application-specific integrated circuit that executes at least some of various types of processes, and a combination of these.

The processor includes a CPU and a memory such as a RAM and a ROM. The memory holds program codes or commands configured to cause the CPU to execute processing. The memory, that is, a computer readable medium includes any readable mediums that can be accessed by general-purpose or dedicated computers.

The control unit 80 controls to drive the first motor 7 to rotate counterclockwise, thereby causing the power of the first motor 7 to be transmitted to the feeding roller 5, the intermediate roller 8, and the pick roller 3 through the power transmitting unit 51. With this configuration, the control unit 80 brings the transport of the medium P into the feeding mode to transport the medium P downstream from the accommodation unit 2.

The control unit 80 controls to drive the first motor 7 to rotate clockwise, thereby causing the power of the first motor 7 to be transmitted to the intermediate roller 8 through the power transmitting unit 51. With this configuration, the control unit 80 brings the transport of the medium P into the transport mode to transport the medium P existing in the feeding path RF toward the downstream.

The control unit 80 controls to drive the first motor 7, thereby causing the power of the first motor 7 to be transmitted to the supplying roller 13 through the power transmitting unit 51. With this configuration, the control unit 80 causes the medium P to be transported from the supply tray 12 toward the feeding path RF.

The control unit 80 controls to drive the second motor 23, thereby causing the printing roller pair 15 to rotate. With this configuration, the control unit 80 causes the medium P to be transported toward the medium support portion 18 disposed downstream of the printing roller pair 15.

The control unit 80 controls to drive the gap adjusting mechanism, thereby adjusting the printing gap. The control unit 80 controls to drive the printing head 40, thereby causing ink to be ejected from the nozzles 44 to the medium P supported by the medium support portion 18. In this manner, the control unit 80 performs printing on the medium P.

The control unit 80 controls to drive the rearward feeding motor, thereby causing the rearward feeding roller pair 19 to rotate. With this configuration, the control unit 80 causes the medium P to be transported toward the discharging path RD downstream of the rearward feeding roller pair 19.

The control unit 80 controls to drive the actuator, thereby causing the switching flap 26 to be moved into the discharging position. The control unit 80 controls to drive the discharging motor, thereby causing the conveying roller pair 27 and the discharging roller pair 28 to rotate in the one way. With this configuration, the control unit 80 causes the most recently printed surface of the medium P to be set as the lower surface to be discharged to the discharging tray 29.

When both-side printing is performed on the medium P, the control unit 80 controls to drive the actuator, thereby causing the switching flap 26 to be moved into the returning position. The control unit 80 controls to drive the discharging motor, thereby causing the conveying roller pair 27 and the discharging roller pair 28 to rotate in the other way. With this configuration, the control unit 80 causes the medium P having one surface on which printing has been performed, to be transported from the discharging path RD toward the returning path RR.

The control unit 80 controls to drive the returning motor, thereby causing the returning roller pair 25 to rotate. With this configuration, the control unit 80 causes the medium P to be transported to the nip portion comprised of the nip roller 11 and the intermediate roller 8. As the medium P is transported in the transport mode, the control unit 80 causes the medium P to be transported to the feeding path RF again.

The control unit 80 causes the medium P that has been transported to the feeding path RF again, to be transported downstream through transporting of the medium P in the transport mode. The control unit 80 controls to drive the second motor 23, thereby causing the printing roller pair 15 to rotate. With this configuration, the control unit 80 causes the medium P to be transported toward the medium support portion 18.

The control unit 80 controls to drive the printing head 40, thereby performing printing on the medium P transported to the medium support portion 18 in a state where the printed surface on which printing has already been performed is set as the lower surface. In this manner, both-side printing is performed on the medium P.

The control unit 80 controls to drive the rearward feeding motor, thereby causing the rearward feeding roller pair 19 to rotate. With this configuration, the control unit 80 causes the medium P on which both-side printing has been performed, to be transported toward the discharging path RD.

The control unit 80 controls to drive the actuator, thereby causing the switching flap 26 to be moved into the discharging position. The control unit 80 controls to drive the discharging motor, thereby causing the conveying roller pair 27 and the discharging roller pair 28 to rotate in the one way. In this manner, the control unit 80 causes the medium P on which both-side printing has been performed, to be discharged to the discharging tray 29 in a state where the most recently printed surface is set as the lower surface.

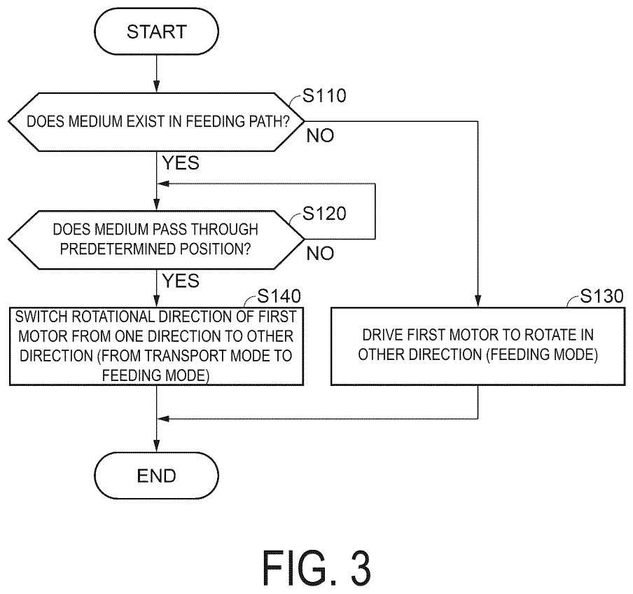

Next, with reference to the flowchart shown in FIG. 3, description will be made of processes performed by the control unit 80 in the feeding process in which the medium P is transported from the accommodation unit 2 to the transport path TR. In the feeding process of the present embodiment, the flow of processes performed by the control unit 80 corresponds to the method of controlling the printing apparatus 1.

In step S110, the control unit 80 checks whether or not the medium P exists in the feeding path RF. In some cases, the feeding process in which the medium P is transported from the accommodation unit 2 to the transport path TR may be performed when printing is performed to the preceding medium Pp, as illustrated in FIG. 5. Alternatively, in some cases, the feeding process may be performed when the preceding medium Pp exists in the feeding path RF.

Thus, at the time of performing the feeding process, the control unit 80 checks whether or not the medium Pp exists in the feeding path RF. As illustrated in FIG. 5, when the medium Pp exists in the feeding path RF, step S110 results in YES, and the control unit 80 moves the process to step S120. As illustrated in FIG. 1, when the medium Pp does not exist in the feeding path RF, step S110 results in NO, and the control unit 80 moves the process to step S130.

Note that, when step S110 results in YES, the first motor 7 is driven to rotate clockwise that is the one direction. Thus, the preceding medium Pp existing in the feeding path RF is transported downstream by the intermediate roller 8. As illustrated in FIG. 5, when printing is performed on the preceding medium Pp, the second motor 23 is driven, whereby the preceding medium Pp is being transported downstream by the printing roller pair 15. When step S110 results in NO, the first motor 7 is not driven.

In step S130, the control unit 80 drives the first motor 7 to rotate counterclockwise that is the other direction. With this process, the control unit 80 brings the transport of the medium P into the feeding mode. As illustrated in FIG. 4, in the feeding mode, the power transmitting unit 51 transmits the power of the first motor 7 to the intermediate roller 8, the feeding roller 5, and the pick roller 3.

In this mode, as the pick roller 3, the feeding roller 5, and the separation roller 6 rotate in the direction of the arrow, the medium P is transported from the accommodation unit 2 toward the downstream that is the direction of the arrow. Once the process of step S130 ends, the control unit 80 ends the feeding process.

In step S120, the control unit 80 checks whether or not the medium Pp passes through the predetermined position. That is, the control unit 80 checks whether or not the preceding medium Pp passes through the position PE. Specifically, when the medium detector 24 changes from a detection state in which the medium P is detected into a non-detection state in which the medium P is not detected, the control unit 80 determines that the trailing end of the preceding medium Pp passed through the position PE. When the detection state from the medium detector 24 is the detection state where the medium P is detected as illustrated in FIG. 5, the control unit 80 determines that the preceding medium Pp pashas not passed through the position PE.

When the control unit 80 determines that the trailing end of the preceding medium Pp passed through the position PE, step S120 results in YES, and the control unit 80 moves the process to step S140. When the control unit 80 determines that the preceding medium Pp has not passed through the position PE, step S120 results in NO, and the control unit 80 continues detection of the medium Pp through the medium detector 24 in step S120.

In step S140, the control unit 80 switches the rotational direction of the first motor 7 from clockwise that is the one direction into the counterclockwise that is the other direction. With this process, the control unit 80 changes the transport of the medium P from the transport mode to the feeding mode. As illustrated in FIG. 7, in the feeding mode, the power transmitting unit 51 transmits the power of the first motor 7 to the intermediate roller 8, the feeding roller 5, and the pick roller 3.

In this mode, as the pick roller 3, the feeding roller 5, and the separation roller 6 rotate in the direction of the arrow, the next medium Pn is transported from the accommodation unit 2 toward the downstream that is the direction of the arrow. Once the process of step S140 ends, the control unit 80 ends the feeding process.

When the feeding process for the next medium Pn ends, the control unit 80 switches the rotational direction of the first motor 7 from counterclockwise to clockwise. With this process, the control unit 80 changes the transport of the medium P from the feeding mode to the transport mode.

Note that, in step S140, when the rotational direction of the first motor 7 is switched from clockwise to counterclockwise, there is a moment at which rotation of the first motor 7 stops as illustrated in FIG. 6. At this time, the preceding medium Pp is nipped by the intermediate roller 8 and the nip rollers 9 and 10. In addition, at this time, printing is performed on the preceding medium Pp by the printing head 40.

In the present embodiment, the one-way clutch 54 is provided in the transmission path TP. Thus, with rotation of the printing roller 16 due to drive of the second motor 23, it is possible to passively rotate the intermediate roller 8 while suppressing an increase in the load acting on the printing roller 16. This makes it possible to suppress the failure of transport of the medium Pp resulting from switching the rotational direction of the first motor 7 during transport of the preceding medium Pp. Thus, it is possible to suppress a deterioration in the printing quality due to switching the rotational direction of the first motor 7 during printing on the preceding medium Pp.

In some cases, the rotational speed of the first motor 7 varies or the rotational speed of the first motor 7 reduces due to a factor different from switching of the rotational direction of the first motor 7 when printing is performed on the medium P. In such a case, with the one-way clutch 54, it is possible to passively rotate the intermediate roller 8 in association with the rotation of the printing roller 16 through drive of the second motor 23. This makes it possible to suppress a variation in the load acting on the printing roller 16. Thus, it is possible to suppress a deterioration in the printing quality due to occurrence of variation in the rotational speed of the first motor 7 or occurrence of a reduction in the rotational speed of the first motor 7 or the like when printing is performed on the preceding medium Pp.

As described above, the printing apparatus 1 according to the first embodiment can provide the following effects.

The printing apparatus 1 includes the feeding roller 5 configured to transport the medium P from the accommodation unit 2 configured to accommodate the medium P, the feeding roller 5 being provided in the feeding path RF disposed downstream of the accommodation unit 2 in the transport direction in which the medium P is transported. The printing apparatus 1 includes the intermediate roller 8 provided in the feeding path RF and at a position downstream of the feeding roller 5 and configured to transport the medium P. The printing apparatus 1 includes the printing roller 16 provided at a position downstream of the intermediate roller 8. The printing roller 16 is configured to transport the medium P toward the medium support portion 18 at which printing is performed on the medium P. The printing apparatus 1 includes the first motor 7 configured to rotate the feeding roller 5 and the intermediate roller 8 through the power transmitting unit 51. The printing apparatus 1 includes the power transmitting unit 51 configured to transmit power of the first motor 7 to the feeding roller 5 and the intermediate roller 8. The printing apparatus 1 includes the second motor 23 configured to rotate the printing roller 16. The power transmitting unit 51 includes the connecting portion in the transmission path TP configured to transmit power of the first motor 7 to the intermediate roller 8. When external force acts, the connecting portion allows the intermediate roller 8 to rotate in accordance with the external force, the external force causing the intermediate roller 8 to rotate in a direction in which the medium P is transported downstream.

With this configuration, it is possible to transport the medium P from the accommodation unit 2 using the feeding roller 5 during printing on the medium P transported by the printing roller 16 and the intermediate roller 8. Thus, it is possible to suppress a deterioration in the throughput at the time of consecutively performing printing on the plurality of media P.

In the transmission path TP, the power transmitting unit 51 includes the drive shaft 53 at which the intermediate roller 8 is rotatably provided, and the connecting portion is provided between the intermediate roller 8 and the drive shaft 53.

With this configuration, it is possible to rotate the intermediate roller 8 in a direction in which the medium P is transported downstream with reduced external force, as compared with a case where the connecting portion is provided at other locations in the transmission path TP. In addition, with this configuration, it is possible to dispose the connecting portion at the inner side of the intermediate roller 8 that is between the intermediate roller 8 and the drive shaft 53. Thus, as the power transmitting unit 51 includes the connecting portion in the transmission path TP, it is possible to easily suppress an increase in the size of the printing apparatus 1.

The connecting portion includes the one-way clutch 54 configured such that, when external force acts on the intermediate roller 8, the intermediate roller 8 is allowed to rotate in a direction in which the medium P is transported downstream. With this configuration, it is possible to dispose the connecting portion in the transmission path TP with a simplified configuration.

When the first motor 7 rotates clockwise, the power of the first motor 7 is transmitted to the intermediate roller 8 through the power transmitting unit 51, whereby the medium P is transported toward the downstream. When the first motor 7 rotates counterclockwise, the power of the first motor 7 is transmitted to the feeding roller 5 and the intermediate roller 8 through the power transmitting unit 51, whereby the medium P is transported from the accommodation unit 2 toward the downstream.

With this configuration, by changing the rotational direction of the first motor 7, it is possible to switch between transporting the medium P downstream in the feeding path RF and transporting the medium P downstream from the accommodation unit 2.

The printing apparatus 1 further includes the control unit 80. It is assumed that, as the printing roller 16 and the intermediate roller 8 rotate, the preceding medium Pp transported downstream passes through the position PE between the feeding roller 5 and the intermediate roller 8 in the feeding path RF. In this case, the control unit 80 switches the rotational direction of the first motor 7 from clockwise to counterclockwise, thereby transporting the next medium Pn toward the downstream from the accommodation unit 2.

With this configuration, it is possible to transport the next medium Pn from the accommodation unit 2 while securing a space between the preceding medium Pp and the next medium Pn during printing on the preceding medium Pp.

The printing apparatus 1 further includes the medium detector 24 at the position PE. Once the medium detector 24 changes from the detection state in which the medium P is detected into the non-detection state in which the medium P is not detected, the control unit 80 determines that the medium P passed through the position PE. With this configuration, it is possible to easily determine that the medium P passes through the position PE.

The printing apparatus 1 according to the above-described embodiment of the present disclosure is basically assumed to have the configuration as described above. However, naturally, it is possible to make modification, omission, and the like of part of the configuration without departing from the main points of the present disclosure. Furthermore, the embodiment described above and other embodiments described below can be implemented by combining one another as long as it does not technically contradict. Below, other embodiments will be described.

The embodiment described above may be configured such that the position PE is not disposed between the feeding roller 5 and the intermediate roller 8 in the feeding path RF, as long as a gap is provided between the preceding medium Pp and the next medium Pn. For example, the position PE may be disposed at a nip portion comprised of the feeding roller 5 and the separation roller 6. Alternatively, the position PE may be disposed at a position between the pick roller 3 and the feeding roller 5.

In the embodiment described above, the printing apparatus 1 may not include the medium detector 24. In this case, it may be possible to determine whether or not the medium P passes through the position PE on the basis of the dimension of the medium P in the transport direction and the amount of transport of the medium P transported downstream after the medium P is detected by the medium detector 22. In this case, the position PL serves as one example of a reference position that is set in advance. Alternatively, it may be possible to determine whether or not the medium P passes through the position PE on the basis of the dimension of the medium P in the transport direction and the amount of transport of the medium P transported downstream after the start of transporting the medium P from the accommodation unit 2. In this case, the position of the leading end of the medium P when it is accommodated in the accommodation unit 2 serves as one example of the reference position that is set in advance.

Alternatively, it may be possible to determine whether or not the medium P passes through the position PE on the basis of the amount of transport of the medium P transported downstream from when the trailing end of the medium P passes through a position disposed, in the Y-axis direction, between the leading end and the trailing end of the medium P accommodated in the accommodation unit 2. In this case, the position disposed, in the Y-axis direction, between the leading end and the trailing end of the medium P accommodated in the accommodation unit 2 serves as one example of the reference position that is set in advance. In this case, a sensor is provided at the reference position so as to be able to detect the medium P.

Alternatively, it may be possible to determine whether or not the medium P passes through the position PE on the basis of the amount of transport of the medium P transported downstream after the start of transporting the medium P from the accommodation unit 2. In this case, the position of the trailing end of the medium P when the medium is accommodated in the accommodation unit 2 serves as one example of the reference position that is set in advance. In this case, a sensor is provided at the reference position so as to be able to detect the medium P.

With the printing apparatus 1 according to these embodiments, it is possible to obtain the following effects. The control unit 80 determines whether or not the medium P passes through the position PE on the basis of the amount of transport of the medium P transported downstream from the reference position that is set in advance. With this configuration, the control unit 80 makes it possible to easily determine whether or not the medium P passes through the position PE.

In the embodiment described above, the power transmitting unit 51 may not include the one-way clutch 54 in the transmission path TP. For example, the power transmitting unit 51 may include an electromagnetic clutch in the transmission path TP, in place of the one-way clutch 54. The electromagnetic clutch is provided in the transmission path TP so as to be able to switch between a coupling state caused by energizing the electromagnetic clutch and a non-coupling state caused by stopping energizing the electromagnetic clutch. In the coupling state, the intermediate roller 8 and the drive shaft 53 are coupled. In the non-coupling state, the intermediate roller 8 is in a state of being able to rotate relative to the drive shaft 53. It may be possible to employ a configuration in which the control unit 80 brings the electromagnetic clutch into the coupling state to bring the transport of the medium P into the transport mode, and brings the electromagnetic clutch into the non-coupling state to bring the transport of the medium P into the feeding mode. In this case, the electromagnetic clutch serves as one example of the connecting portion.

What is claimed is:

1. A printing apparatus comprising:
a feeding roller configured to transport a medium from an accommodation unit configured to accommodate the medium, the feeding roller being provided in a transport path disposed downstream of the accommodation unit in a transport direction in which the medium is transported;
an intermediate roller provided in the transport path and at a position downstream of the feeding roller and configured to transport the medium;
a printing roller provided at a position downstream of the intermediate roller and configured to transport the medium toward a medium support portion at which printing is performed on the medium;
a first motor configured to rotate the feeding roller and the intermediate roller through a power transmitting unit;
the power transmitting unit configured to transmit power of the first motor to the feeding roller and the intermediate roller; and
a second motor configured to rotate the printing roller, wherein
the power transmitting unit includes a connecting portion in a transmission path configured to transmit power of the first motor to the intermediate roller, and
when external force acts, the connecting portion allows the intermediate roller to rotate in accordance with the external force, the external force causing the intermediate roller to rotate in a direction in which the medium is transported downstream.

2. The printing apparatus according to claim 1, wherein
in the transmission path, the power transmitting unit includes a drive shaft at which the intermediate roller is rotatably provided, and
the connecting portion is provided between the intermediate roller and the drive shaft.

3. The printing apparatus according to claim 1, wherein
the connecting portion includes a one-way clutch configured to allow the intermediate roller to rotate in a direction in which the medium is transported downstream when the external force acts on the intermediate roller.

4. The printing apparatus according to claim 1, wherein
when the first motor rotates in one direction, power of the first motor is transmitted to the intermediate roller through the power transmitting unit to transport the medium downstream, and
when the first motor rotates in another direction, power of the first motor is transmitted to the feeding roller and the intermediate roller through the power transmitting unit to transport the medium downstream from the accommodation unit.

5. The printing apparatus according to claim 4 further comprising
a control unit, wherein
when, as the printing roller and the intermediate roller rotate, a previous medium transported downstream passes through a predetermined position disposed between the feeding roller and the intermediate roller in the transport path, the control unit switches a rotational direction of the first motor from the one direction to the other direction to transport a next medium downstream from the accommodation unit.

6. The printing apparatus according to claim 5 further comprising
a medium detector at the predetermined position, wherein
when the medium detector changes from a detection state in which the medium is detected into a non-detection state in which the medium is not detected, the control unit determines that the medium passed through the predetermined position.

7. The printing apparatus according to claim 5, wherein
the control unit determines whether the medium passed through the predetermined position on a basis of an amount of transport of the medium transported downstream from a reference position that is set in advance.
